(19) United States
(12) Patent Application Publication
(10) Pub. No.: US 2016/0267015 A1
(43) Pub. Date: Sep. 15, 2016

(54) MAPPING VIRTUAL MEMORY PAGES TO PHYSICAL MEMORY PAGES

(71) Applicant: HEWLETT PACKARD ENTERPRISE DEVELOPMENT LP, Houston, TX (US)

(72) Inventors: Sheng Li, Palo Alto, CA (US); Jishen Zhao, Palo Alto, CA (US); Jichuan Chang, Palo Alto, CA (US); Parthasarathy Ranganathan, Palo Alto, CA (US); Alistair Veitch, Palo Alto, CA (US); Kevin T. Lim, Palo Alto, CA (US)

(21) Appl. No.: 15/031,181

(22) PCT Filed: Oct. 29, 2013
(86) PCT No.: PCT/US2013/067239

§ 371 Date: Apr. 21, 2016

(51) Int. Cl. G06F 12/10

(52) U.S. Cl. CPC G06F 12/109; G06F 2212/1041; G06F 2212/152; G06F 2212/657

(57) ABSTRACT

A method for mapping virtual memory pages to physical memory pages is described. The method includes receiving a mapping of a virtual memory page to multiple physical memory pages, detecting a request for a transaction to be performed on data contained in the multiple physical memory pages, in which the transaction includes a number of data updates, determining which of the number of multiple physical memory pages contains a latest version of the data to be updated by the transaction, updating a physical memory page by performing the transaction within a physical memory page among the multiple physical memory pages that does not contain the latest version of the data, and updating an indication of which of the physical memory pages contains the latest version of the data pertaining to the transaction.

### BACKGROUND

Memory devices are used to store data. For example, data centers may use memory devices to store large amounts of data. The performance of the data centers may rely heavily on the performance of these memory devices. One particular type of memory, byte-addressable non-volatile memory, may allow users to quickly access data and allow the data to remain on the memory device after power is removed from the memory device.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram of a system for mapping virtual memory pages to physical memory pages according to one example of the principles described herein.

FIG. 2 is a flowchart of a method for mapping virtual memory pages to physical memory pages according to one example of the principles described herein.

FIG. 3 is a diagram of a version controller and physical memory pages according to one example of the principles described herein.

FIG. 4 is a flowchart of another method for mapping virtual memory pages to physical memory pages according to another example of the principles described herein.

FIG. 5 is a diagram of a version controller according to one example of the principles described herein.

FIG. 6 is a version indicator table according to one example of the principles described herein.

Throughout the drawings, identical reference numbers designate similar, but not necessarily identical, elements.

### DETAILED DESCRIPTION

As described above, data centers, among other entities, may process large amounts of data and may use memory systems to store the data. Byte-addressable non-volatile memory may be used because it exhibits properties of volatile and non-volatile memory. For example, byte addressable non-volatile memory may exhibit speeds comparable to volatile memory and may also have the ability to retain the data after power is removed from the system comparable to non-volatile memory. Using byte-addressable non-volatile memory, an application may store user-defined data structures in non-volatile memory, process large amounts of data with low latency and high bandwidth and allow large and complex data structures to be readily accessed. However, updating non-volatile memory may corrupt the data in the non-volatile memory due to failures, memory leaks, or application bugs.

Accordingly, persistent memory may be used to preserve the data. High performance persistent memory may be beneficial in that it allows large and complex data structures to be readily accessible when a program starts or after a system or program reboot. Such access may improve system performance, especially in data centers that include large scale in-memory data structures. Some persistent memory is versioned which may preserve the integrity of data in the face of system crashes due to power outages and kernel panics, among other causes. While many high performance persistent memory systems may be beneficial, there are many complications that make persistent memory slow, inefficient, and hard to design for.

For example, current methods rely on complex mechanisms for establishing persistence in memory. These mechanisms may be very complicated and may impose high performance costs and may have considerable overhead in terms of performance and power consumption. More specifically, multi-versioned data structures may use a copy-on-write approach to store updates in a temporary data buffer which may include changes to operating systems, runtime engines, or combinations thereof to manage the metadata. The systems and methods described herein may be beneficial in that they may be implemented with few modifications to existing operating systems, processor architectures, and memory architectures.

Accordingly, the present disclosure describes systems and methods for mapping virtual memory pages to physical memory pages. As will be described below, in non-volatile memory, a set of shadow or secondary physical memory pages may be established that are linked to a first or original physical memory page. When a transaction that includes a number of updates is requested to be made to the data in the original physical memory page, the transaction may be performed to the data in the shadow physical memory page. When all updates in the transaction have been made, the shadow physical memory page may be designated as the page having the latest version of the data. In other words, from a programmer's perspective, each memory update is performed to a physical memory page corresponding to a virtual memory page. However, the updates are actually directed to different locations on a physical memory device (e.g., the original physical memory page or the shadow physical memory page) depending on a trigger by the hardware, which trigger is based on which of the original page or the shadow page has the latest version of the data.

The present disclosure describes a method for mapping virtual memory pages to physical memory pages. The method may include receiving a mapping of a virtual memory page to multiple physical memory pages. The method may also include detecting a request for a transaction to be performed on data contained in the multiple physical memory pages. The transaction may include a number of data updates. The method may also include determining which of the multiple physical memory pages contains a latest version of the data. The method may further include updating a physical memory page by performing the transaction within a physical memory page of the multiple physical memory pages that does not contain the latest version of the data. The method may further include updating an indication of which of the multiple physical memory pages contains the latest version of the data.

The present disclosure describes a system for mapping virtual memory pages to physical memory pages. The system may include a processor. The system may also include memory communicatively coupled to the processor. The system may also include a version controller. The version controller may include a page descriptor module to receive a mapping of a virtual memory page to multiple physical memory pages. The version controller may include a version indicator table to indicate which of the multiple physical memory pages contains a latest version of data represented by the virtual memory page. The version controller may include a request buffer to perform a number of updates on one of the multiple physical memory pages. The version controller may also include a table update module to update the version indicator table after one of the multiple physical memory pages has been updated.

The present disclosure describes a computer program product for mapping virtual memory pages to physical memory pages. The computer program product includes a computer readable storage medium including computer usable program code embodied therewith. The computer usable program code includes computer usable program code to, when executed by a processor, detect a number of updates to be performed on data contained in multiple physical memory pages, identify a master page of the multiple physical memory pages, in which the master page contains the latest version of the data, and perform the data updates on a shadow page, in which a shadow page is a page of the multiple physical memory pages that does not contain the latest version of the data, and update an indication of which of the multiple physical memory pages contains the latest version of the data.

As used in the present specification and in the appended claims, the term “persistent memory” may include memory that is atomic, consistent, isolated, and durable.

Further, as used in the present specification and in the appended claims, the term “atomic,” “atomically,” “atomicity,” or similar terms may refer to a transaction where all the operations occur, or none of the operations occur. For example, an atomic update transaction may be a transaction where all updates that make up the transaction are performed, or none of the updates are performed. As will be described below, atomicity may be provided by the version controller.

Still further, as used in the present specification and in the appended claims, the term “consistent,” “consistency,” or similar terms may refer to a transaction that operates between a number of defined operable states and ensures that data is valid in each state. For example, update operations performed out of order where one of the updates has been performed and another has not been performed may lead to inconsistent memory. Consistency may be provided by an operating system.

Still further, as used in the present specification and in the appended claims, the term “isolation” may refer to a property of memory that a transaction does not affect concurrent transactions. Isolation may be provided by an operating system.

Still further, as used in the present specification and in the appended claims, the term “durable,” “durability,” or similar terms may refer to a property of memory wherein data is retained in a state even after a power loss, crash or error. For example, updates may be installed in non-volatile memory. As will be described below, durability may be provided by the versioned memory system described below which may include non-volatile memory.

Still further, as used in the present specification and in the appended claims, the term “latest version of the data” may refer to a version of the data that corresponds to a current transaction. For example, data may exist in a tenth version. However, a current transaction may treat the fifth version as the latest version of the data.

Even further, as used in the present specification and in the appended claims, the term “a number of” or similar language may include any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

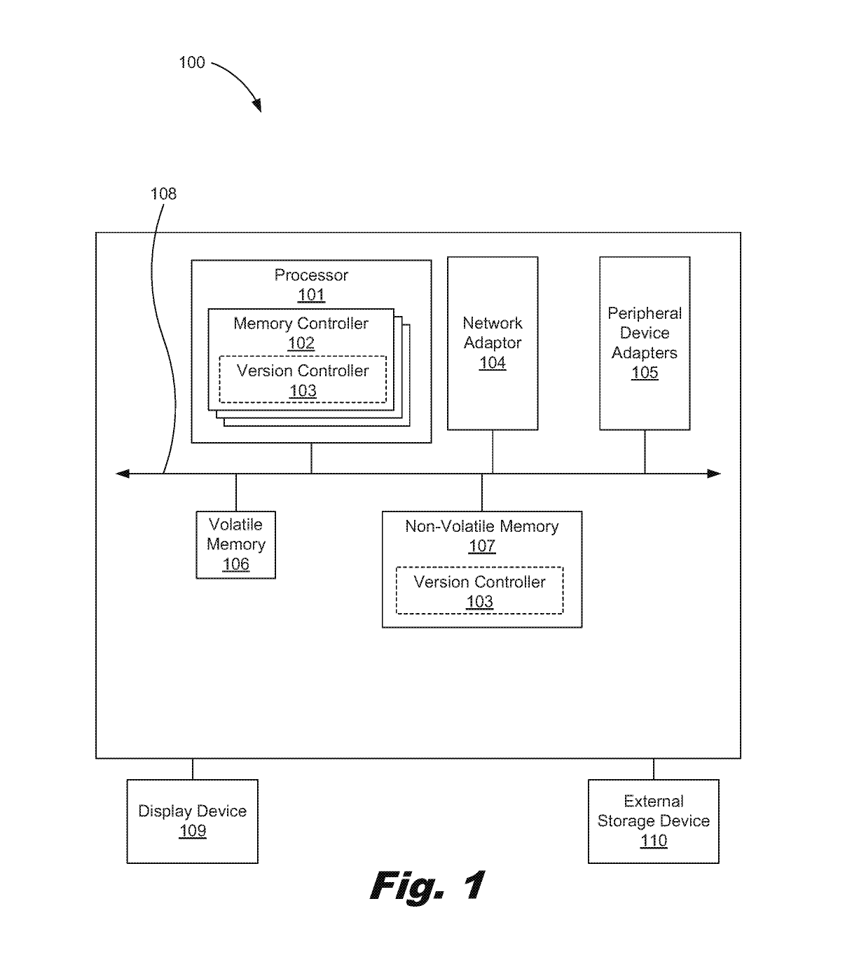

Turning now to the figures, FIG. 1 is a diagram of a system (100) for establishing atomic and durable memory using a versioned memory design, according to one example of the principles described herein. The system (100) may be utilized in any data processing scenario including, for example, a cloud computing service such as a Software as a Service (SaaS), a Platform as a Service (PaaS), a Infrastructure as a Service (IaaS), application program interface (API) as a service (APIaaS), other forms of network services, or combinations thereof. Further, the system (100) may be used in a public cloud network, a private cloud network, a hybrid cloud network, other forms of networks, or combinations thereof. In one example, the methods provided by the system (100) are provided as a service over a network by, for example, a third party. In another example, the methods provided by the system (100) are executed by a local administrator.

Further, the system (100) may be utilized within a single computing device. In this data processing scenario, a single computing device may utilize the hierarchical dictionary and other associated methods described herein to scan, store, and/or transmit compressed versions of single or multi-page documents.

To achieve its desired functionality, the system (100) comprises various hardware components. Among these hardware components may be a number of processors (101), a number of network adapters (104), and a number of peripheral device adapters (105). These hardware components may be interconnected through the use of a number of busses and/or network connections. In one example, the number of busses that interconnect one or more of these devices may be represented by the reference numeral (108). In other words, the reference numeral (108) may designate a connection and may not indicate a particular number of connections. For example, memory (106, 107) may be connected to one or more other elements of the system (100) and may use a bus distinct from a bus used by the peripheral device adapters (105) to communicate with other elements of the system (100).

The processor (101) may include the hardware architecture to retrieve executable code and execute the executable code. The executable code may, when executed by the processor (101), cause the processor (101) to implement at least the functionality of establishing atomicity and durability using a versioned memory design, according to the methods of the present specification described herein. In the course of executing code, the processor (101) may receive input from and provide output to a number of the remaining hardware units.

The system (100) may store data such as executable program code that is executed by the processor (101) or other processing device. As will be discussed, the system (100) may specifically store a number of applications that the processor (101) executes to implement at least the functionality described herein.

The system (100) may include various types of memory modules, including volatile memory (106) and non-volatile memory (107). In some examples, the non-volatile memory (107) may be byte-addressable non-volatile memory (107). In other examples, the systems and methods described herein may be implemented with other types of durable memory and storage devices such as hard disk drives (HDD) and solid state drives (SSD). An example of volatile memory (106) may include Dynamic Random Access Memory (DRAM) in a dual in-line memory module (DIMM). An example of non-volatile memory (107) may include Read Only Memory (ROM), and Hard Disk Drive (HDD) memory. Similarly, the non-volatile memory (107) may be dual in-line memory modules (DIMMs). Many other types of memory may also be utilized, and the present specification contemplates the use of many varying type(s) of memory in the system (100) as may suit a particular application of the principles described herein. In certain examples, different types of memory in the system (100) may be used for different data storage needs.

Generally, the system (100) may comprise a computer readable medium, a computer readable storage medium, or a non-transitory computer readable medium, among others. For example, the system (100) may include an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. In another example, a computer readable storage medium may be any non-transitory medium that can contain, or store a program for use by or in connection with an instruction execution system, apparatus, or device.

The hardware adapters (105) in the system (100) enable the processor (101) to interface with various other hardware elements, external and internal to the system (100). For example, peripheral device adapters (105) may provide an interface to input/output devices, such as, for example, display device (109) or access other external devices such as an external storage device (110). The display device (109) may be provided to allow a user to interact with and implement the functionality of the system (100). The peripheral device adapters (105) may also create an interface between the processor (101) and a printer, the display device (109), or other media output device. The network adapter (104) may provide an interface to other computing devices within, for example, a network, thereby enabling the transmission of data between the system (100) and other devices located within the network.

The processor (101) may include a number of memory controllers (102) that control the memory (106, 107) of the system (100). The processor (101) may include a memory controller (102) for individual instances of memory (106, 107). For example a first memory controller (102) may control the volatile memory (106) and a second memory controller (102) may control the non-volatile memory (107).

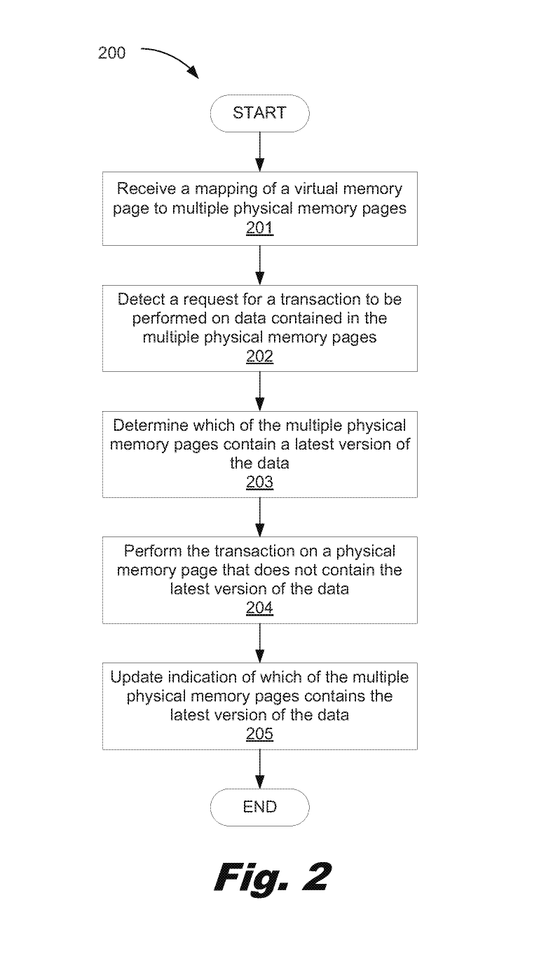

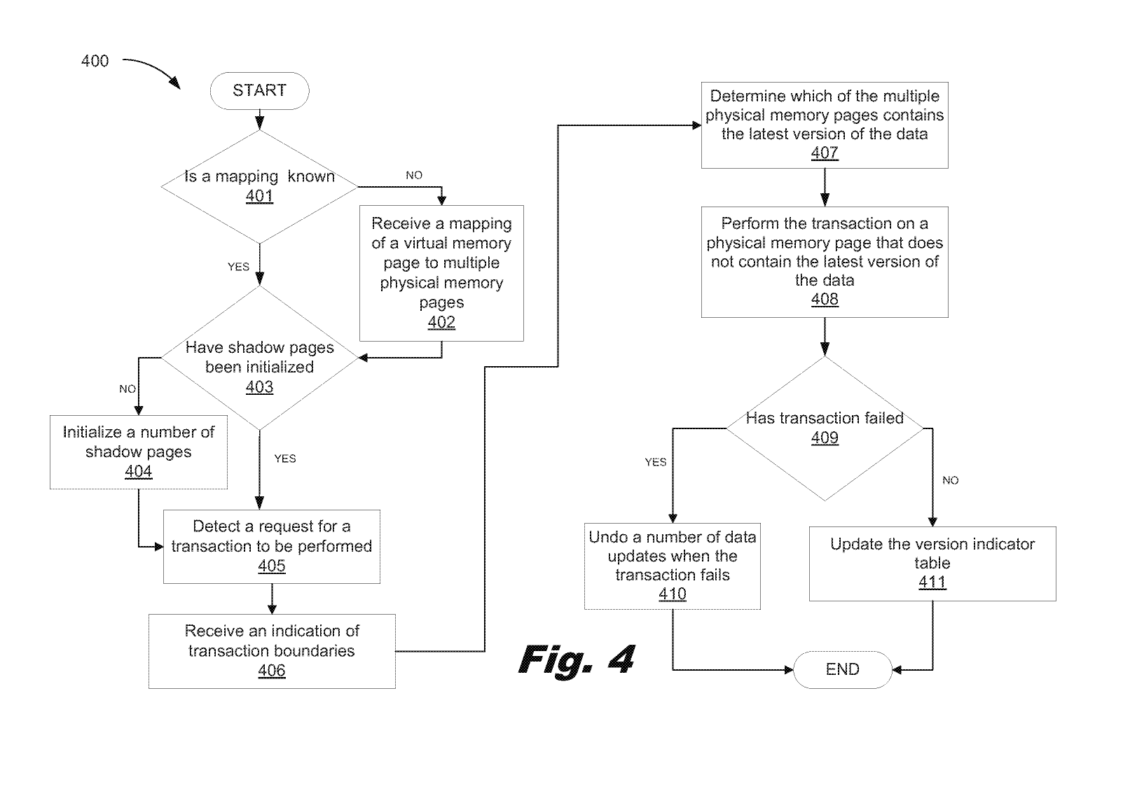

In some examples, the memory controller (102) may include a version controller (103) that manages the updating of physical memory pages. For example, the version controller (103) may receive a mapping of a virtual memory page to multiple physical memory pages such as a master physical memory page and a shadow memory page. The version controller (103) may also indicate which of the multiple physical memory pages contains the latest version of the data, via a version indicator table for example. In other words, the version controller (103) may indicate which of the multiple physical memory pages contains a version of the data that corresponds to a transaction currently being performed. The version controller (103) may update the version indicator table to reflect changes in which of the multiple physical memory pages contains the latest version of the data. The version controller (103) may also include a request buffer that performs updates on the data contained in the multiple physical memory pages. More detail concerning the functionality of the version controller (103) is given below in connection with at least FIGS. 2 and 4.

As indicated in FIG. 1, in some examples, the version controller (103) may be part of the processor (101). More specifically, the version controller (103), or the functionality of the version controller (103) may be controlled by a memory controller (102) coupled to non-volatile memory (107). In another example, the version controller (103) may be included on the non-volatile memory (107) of the system (100).

FIG. 2 is a flowchart of a method (200) for establishing atomic and durable memory using a versioned memory design, according to another example of the principles described herein. The method (200) may include receiving (block 201) a mapping of a virtual memory page to multiple physical memory pages. A virtual memory page may refer to a memory page that is visible to an application or a program while physical memory pages may be physical memory addresses where data is stored. The mapping may indicate a physical address where data represented in a virtual memory is located. Accordingly, when a request is made, via a virtual memory page, to update data, the mapping may direct a processor (FIG. 1, 101) to the correct physical address to update the data in the physical memory page.

An example of receiving (block 201) a mapping is given as follows. In this example, an operating system may generate a mapping from a virtual memory location to the data location in multiple physical memory pages. More specifically, the version controller (FIG. 1, 103) may receive the mapping via a special memory address or mapped registers in the version controller (FIG. 1,103). Examples of mapping structures may include stride and linear mapping functions. In one specific example, data represented in a virtual memory page may be stored in two physical memory pages. Accordingly, the virtual memory page may have a one-to-two mapping. In this example, either one of the physical memory pages may be a potential physical destination for the data indicated in the corresponding virtual memory page. While this example references a one-to-two mapping, any number of physical memory pages may be used which may indicate a virtual memory page may have a one-to-many mapping. The number of physical memory pages that map to a virtual memory page may depend on the desired number of versions of the data. For example, if a new version and an old version for the data is sufficient, then the one-to-two mapping may be used. By comparison, if an application implements more than two versions, then a one-to-many mapping may be used.

The version controller (FIG. 1, 103) may detect (block 202) a request for a transaction to be performed on data contained in the multiple physical memory pages. For example, a programmer, via a virtual memory page, may change data in the virtual memory page. Accordingly, the version controller (FIG. 1, 103) may detect that a change has been requested. The change may trigger a request for a transaction to be performed on the data in a physical memory page. In some examples, the transaction may include a number of updates to be made to the data contained in the physical memory pages.

The transaction may be an atomic transaction. As described above, an atomic transaction may refer to a transaction where all the operations are performed, or none of the operations are performed. Accordingly, an atomic transaction request may be completed when all the updates that make up the transaction are completed. By comparison, an atomic transaction may fail if less than all of the updates that make up the transaction are completed.

The version controller (FIG. 1, 103) may determine (block 203) which of the multiple physical memory pages contains a latest version of the data. More specifically, the version controller (FIG. 1, 103) may determine (block 203) which of the multiple physical memory pages contains a latest version of a portion of data that is to be updated by the transaction. For example, as described above, a virtual memory page may have two corresponding physical memory pages that may potentially be the physical locations for the data. Accordingly, the version controller (FIG. 1, 103) may indicate whether a master physical memory page has the latest version of the data or whether a shadow physical memory page has the latest version of the data. As used herein, the latest version of the data may refer to a version of the data that has had a most recent atomic transaction completed. As will be described in more detail below, the version controller (FIG. 1, 103) may include a version indicator table to indicate which physical memory page contains the latest version of the data.

The version controller (FIG. 1, 103) may perform (block 204) the transaction on a physical memory page. More specifically, the version controller (FIG. 1, 103) may perform (block 204) the transaction on a physical memory page that does not contain the latest version of the data. Performing (block 204) the transaction may include performing a number of updates to the data stored in the physical memory page. In some examples, prior to performing a transaction such as performing an update, the contents of a physical memory page may be copied to another physical memory page in a process that may be referred to as initialization. More detail regarding initialization is given below in connection with FIG. 4.

As described above, the transaction may be an atomic transaction such that the transaction is not completed until all the data updates in the transaction are completed. Accordingly, once all the data updates are completed, the atomic transaction may be committed and the version controller (FIG. 1, 103) may update the version indicator table to indicate that the memory page on which the updates were performed now contains the latest version of the data.

The version controller (FIG. 1, 103) may update (block 205) an indication of which of the multiple physical memory pages contains the latest version of the data as seen by the transaction. As described above, a version indicator table may indicate which of the multiple physical memory pages contains a latest version of the data. Once an atomic transaction has been completed, the page that contains the latest version of the data may be different than before the atomic transaction. Accordingly, an indication, such as an entry in a version indicator table may be updated to reflect the change.

Performing a transaction on a physical memory page that does not contain the latest version of the data may be beneficial in that a version of the data is maintained such that if the update fails due to power failure, kernel panic, or a crash, among other failures, the system (FIG. 1, 100) may roll back to a previous version of the data while not losing much information. Similarly, implementing aversion controller (FIG. 1, 103), and a corresponding versioning functionality, on hardware such as a processor (FIG. 1, 101) or non-volatile memory (FIG. 1, 107) may be beneficial in that it does not expose the complicated multi-versioned design to a programmer, rather it is included in a hardware design. In other words, an application or a program may indicate a change regardless of the physical memory page mapped to the virtual memory page. The actual physical memory page that is mapped may be hidden to the application or program which may increase the simplicity of mapping while providing a readily accessible memory system.

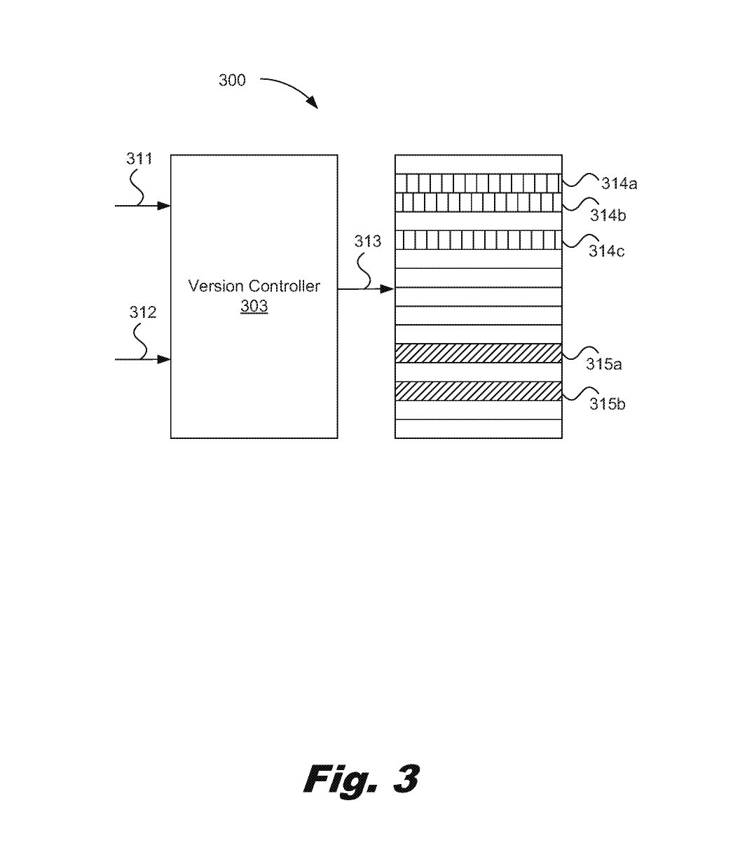

FIG. 3 is a diagram of a version controller (303) and physical memory pages (314, 315), according to one example of the principles described herein. As described above a virtual memory page may be mapped to multiple physical memory pages (314, 315). For example, the virtual memory page may be mapped to a number of master physical memory pages (314) and a number of shadow physical memory pages (315). Each of the master physical memory pages (314) and the number of shadow physical memory pages (315) may contain data indicated in the virtual memory pages. In some examples, the master physical memory pages (314) and the shadow physical memory pages (315) may contain different versions of the data. For example, the master physical memory pages (314) may include a sixth version of the data and the shadow physical memory pages (315) may include a fourth version of the data. Accordingly, when an operating system, or other device, allocates the physical memory pages, data from the master physical memory pages (314) may be copied to the shadow physical memory pages (315) when the shadow physical memory pages (315) are initialized. Having multiple physical memory pages (314, 315) mapped to a virtual memory page may be beneficial in that there may be multiple potential physical locations where data may be stored.

In one example, multiple virtual memory pages, or blocks pertaining to multiple virtual memory pages may be grouped together and mapped to one physical memory page. An example is given as follows. In this example, an application may request a transaction for blocks of memory in two virtual memory pages. More specifically, an application may request an update to a first block of a first virtual memory page and an update to a first block of a second virtual memory page. Performing the transaction on multiple physical memory pages may be inefficient as part of the data of a multiple physical memory page that may be updated. In this example, an operating system may generate a mapping of the multiple virtual memory pages to a single physical memory page. For example, a first portion of the single physical memory page may correspond to the first block of the first virtual memory page, and a second portion of the single physical memory page may correspond to the first block of the second virtual memory page. Mapping multiple virtual memory pages to a single physical memory page may be beneficial in that the amount of memory space for maintaining multiple versions of data can be reduced when applications make sparse persistent changes on large data structures.

When mapping multiple virtual memory pages to a single physical memory page, multi-versioning the single physical memory page may also be performed to maintain the shadow (315) physical memory page properties. In this example, the single physical memory page may be a group of physical memory segments. For example, a first physical memory segment may act as a main page for the multiple virtual pages, and a second physical memory segment may be a shadow page of the group of virtual pages.

Each of the master physical memory pages (314) and the shadow physical memory pages (315) may contain different versions of the data. For example, the master physical memory pages (314) may contain original data and the shadow physical memory pages (315) may contain the original data plus an update. Storing different versions of the data in different locations in physical memory may be beneficial in that if an update being performed on data in the shadow physical memory pages (315) fails, the system (FIG. 1, 100) may roll back to the state of the data in the master physical memory pages (314) with little to no information loss.

An example of a mapping from a virtual memory page to multiple physical memory pages and the performance of a transaction are given as follows. In this example, the version controller (303) may receive a mapping function (311). For example, as described above, an operating system may allocate space on a physical memory system for data represented in the virtual memory page to be stored. In other words, the version controller (303) may receive an indication of multiple sets of pages that may be allocated for physical storage of the data. Using this information, the version controller (303) may maintain a record of which of the physical memory pages (314, 315) contain the latest version of the data.

The version controller (303) may also receive a request (312) to perform a transaction. For example, the version controller (303) may receive a request (312) to perform a number of updates to data stored in the physical memory pages (314, 315). Based on the request (312) and the mapping function (311), the version controller may identify which of the master physical memory pages (314) and the shadow physical memory pages (315) contain the latest version of the data. The version controller (303) may then perform a transaction (313) on the physical memory page that does not contain the latest version of the data. While FIG. 3 depicts and describes two physical memory pages, any number of physical memory pages may be implemented according to the methods and systems described herein.

FIG. 4 is a flowchart of another method (400) for establishing atomic and durable memory using a versioned memory design, according to another example of the principles described herein. It may be determined (block 401) whether a version controller (FIG. 1, 103) is aware of a mapping between a virtual memory page and a number of physical memory pages (FIG. 3, 314, 315). If the version controller (FIG. 1, 103) is not aware of the mapping (block 401, decision NO), the method (400) may include receiving (block 402) a mapping of a virtual memory page to multiple physical memory pages (FIG. 3, 314, 315). This may be performed as described in connection with FIG. 2. As described above, the mapping may be at a whole page level. Similarly as described above, the mapping may be from multiple virtual memory pages to a single physical memory page. In some examples, in generating a mapping, the operating system, or other device, may query a version controller (FIG. 1, 103) for current page mappings.

In generating and sending the mapping, an operating system may rely on a virtual memory manager to generate the physical memory pages (FIG. 3, 314, 315) and the mappings. The mapping may also be generated to support granularity different from the virtual memory pages in a system (FIG. 1, 100). By comparison, if the version controller (FIG. 1, 103) is aware of the mapping (block 401, decision YES), the version controller (FIG. 1, 103) may determine (block 402) whether the shadow physical memory pages (FIG. 3, 315) have been initialized. If the shadow physical memory pages (FIG. 3, 315) have not been initialized (block 403, decision NO), the version controller may initialize (block 404) a number of shadow physical memory pages (FIG. 3, 315). As described above, the systems and methods described herein describe multiple physical memory pages (FIG. 3, 314, 315) being mapped to a virtual memory page. Accordingly, data contained in a number of master physical memory pages (FIG. 3, 314) may be copied to a number of shadow physical memory pages (FIG. 3, 315) according to the mapping received from an operating system. In some examples, transactions (FIG. 3, 313) may be performed during the initialization process. For example, a number of updates may be performed on a number of physical memory pages (FIG. 3, 314, 315) while other pages are being initialized. Allowing performance of updates on some pages while other pages are being initialized may be beneficial in that the latency of initialization is reduced and update operations may be performed more efficiently, especially for memory transactions that include a large memory footprint.

After initializing (block 404) the number of shadow physical memory pages (FIG. 3, 315), or after determining that the shadow physical memory pages (FIG. 3, 315) have been initialized (block 403, decision YES), the version controller (FIG. 1, 103) may detect (block 405) a request (FIG. 3, 312) for a transaction (FIG. 3, 313) to be performed on data contained in the multiple physical memory pages (FIG. 3, 314, 315). This may be performed as described in connection with FIG. 2.

The version controller (FIG. 1, 103) may receive (block 406) an indication of transaction (FIG. 3, 313) boundaries. For example, an operating system may send to the version controller (FIG. 1, 103) specifications on an atomic transaction (FIG. 3, 313). In one example, the version controller (FIG. 1, 103) may receive a starting and ending point of a transaction (FIG. 3, 313). Accordingly, any update that occurs between the starting point and ending point may be one transaction (FIG. 3, 313), and once those updates are completed, the transaction (FIG. 3, 313) may be completed. In other words, the transaction (FIG. 3, 313) may be an atomic transaction (FIG. 3, 313). The version controller (FIG. 1, 103) may receive (block 404) an indication of the transaction (FIG. 3, 313) boundaries using transactional semantics, memory writes to special memory locations or memory mapped registers, an msync( )interface or other communication forms.

In another example, the version controller (FIG. 1, 103) may receive an indication of a memory region that defines the physical memory page (FIG. 3, 314, 315). Accordingly, any update that fits within the indicated region may be part of one transaction (FIG. 3, 313), and once those updates are completed, the transaction (FIG. 3, 313) may be completed.

The version controller (FIG. 1, 103) may determine (block 407) which of the multiple physical memory pages (FIG. 3, 314, 315) contains the latest version of the data. This may be performed as described in connection with FIG. 2. As described above, in some examples, a version indicator table may be updated based on a committed transaction. The update may indicate a different physical memory page (FIG. 3, 314, 315) contains the latest version of the data. Accordingly, subsequent requests (FIG. 3, 312) for a transaction (FIG. 3, 313) may be redirected based on the update to the version indicator table. Continuing the example above, rather than directing a transaction (FIG. 3, 313) to be performed within the master physical memory page (FIG. 3, 314), the transaction (FIG. 3, 313) may be redirected to the shadow physical memory page (FIG. 3, 315).

The version controller (FIG. 1, 103) may perform (block 408) the transaction (FIG. 3, 313) on a physical memory page (FIG. 3, 314, 315) that does not contain the latest version of the data. This may be performed as described in connection with FIG. 2. More specifically, performing (block 408) the transaction may include performing one or more updates to a physical memory page (FIG. 3, 314, 315). Once the transaction is completed, the data may remain in the updated page, a property referred to as durability. In some examples, a number of pages may be grouped together such that transactions are performed (block 406) on the group together.

In some examples, one or more of the steps may be repeated for various updates or transactions. For example, after performing (block 408) the transaction, a subsequent request for a transaction may be detected (block 405). In this example, the version controller (FIG. 1, 103) may update a mapping such that repeated updates within a transaction may be performed on a proper physical memory page (FIG. 3, 314, 315).

As described above, the transaction (FIG. 3, 313) may be an atomic transaction (FIG. 3, 313) in which all the updates in a transaction are completed, or none of the updates in a transaction are completed. Accordingly, the version controller (FIG. 1, 103) may determine (block 409) whether a transaction has failed. In other words, the version controller (FIG. 1, 103) may determine whether a number of updates that makes up a transaction have been completed. In some examples, determining (block 409) whether a transaction has failed may include receiving an indication from another module. The other module may direct the version controller (FIG. 1, 103) to commit the transaction or to abort the transaction. For example, the version controller (FIG. 1, 103) may receive (block 404) an indication of whether to abort a transaction or commit a transaction using transactional semantics, memory writes to special memory locations or memory mapped registers, an msync( )interface or other communication forms.

If the number of updates that are included in a transaction have not been completed, indicating that the transaction has failed (block 409, decision YES), the version controller (FIG. 1, 103) may undo (block 410) a number of data updates. In some examples, undoing (block 410) a number of updates may be performed as follows. Since the updates are performed on physical memory pages (FIG. 3, 314, 315) that do not contain the latest data, and because the version indicator table has not been updated, the pointers may still point to the physical memory page (FIG. 3, 314, 315) that contains the latest version of the data. In another example, undoing (block 410) a number of updates may include ensuring that the version indicator table indicates the correct mapping to the latest version of the data. For example, if a transaction is aborted, the “old” version of the data may be indicated in the version indicator table as the latest version of the data. In this example, additional operations may be omitted and the latest version of the data (resulting from the last committed transaction) may be preserved and properly represented in the version indicator table.

By comparison, if the number of updates that are included in a transaction have been completed, the transaction may be successful (block 409, decision NO). In this example, the transaction may be committed, and the version indicator table may be updated (block 411). In other words, the version controller (FIG. 1, 103) may update (block 411) aversion indicator table to indicate which of the multiple physical memory pages (FIG. 3, 314, 315) contains the latest version of the data. In other words, after all the data updates of an atomic transaction (FIG. 3, 313) have been completed, a new version of the data exists on a physical memory page (FIG. 3, 314, 315). A version indicator table that reflects which page has the latest version is accordingly updated to reflect the change in which page contains the latest version of the data. An example is given as follows. A version indicator table may indicate that a master physical memory page (FIG. 3, 314) may contain the latest version of data. A request (FIG. 3, 312) may be made to perform a transaction (FIG. 3, 313) on the data. Accordingly, the transaction (FIG. 3, 313) may be performed on a shadow physical memory page (FIG. 3, 315). After the transaction (FIG. 3, 313) is performed, the shadow physical memory page (FIG. 3, 315) may contain the latest version of the data on account of the recent transaction. Accordingly, the version indicator table may be updated, and the shadow physical memory page (FIG. 3, 315) may be indicated as the page that contains the latest version of the data.

While FIG. 4 depicts the blocks occurring in a particular order, a number of the blocks may be performed in a different order. For example, the version controller (FIG. 1, 103) may receive (block 406) an indication of transaction boundaries, and then determine (block 401) whether a mapping is known and determine (block 403) if secondary pages have been initialized.

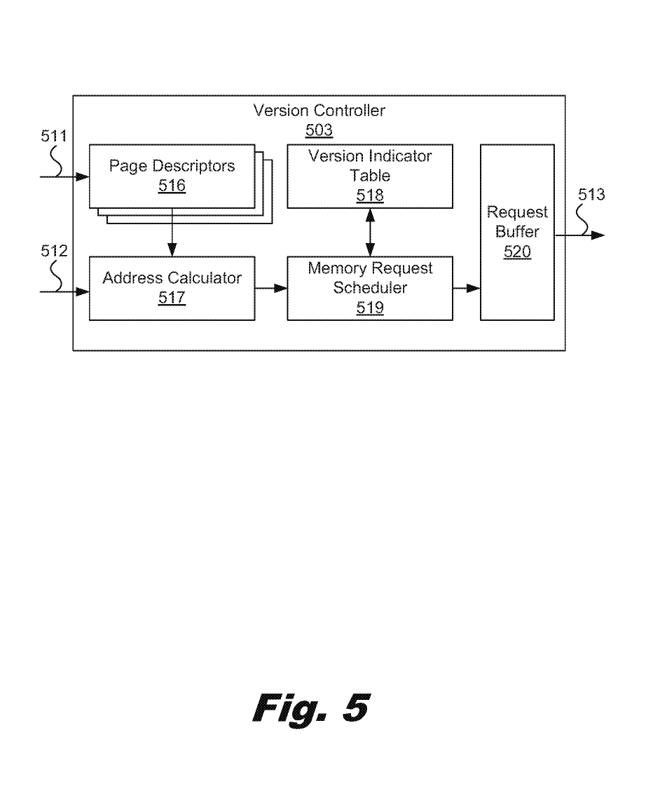

FIG. 5 is a diagram of a version controller (503), according to one example of the principles described herein. The version controller (503) may include a number of page descriptors (516). The page descriptors (516) receive the mapping function (511), for example from the operating system. The page descriptors (516) may be used to specify a mapping between virtual memory pages and physical memory pages (FIG. 3, 314, 315). In other words, the page descriptors (516) indicate which physical memory pages (FIG. 3, 314, 315) the operating system has designated as being potential physical locations of the data. As described above, the page descriptors (516) may include a mapping on a whole page level (i.e., one whole virtual memory page to one whole physical memory page) or a subpage level (i.e., multiple blocks of different virtual memory pages to one physical memory page).

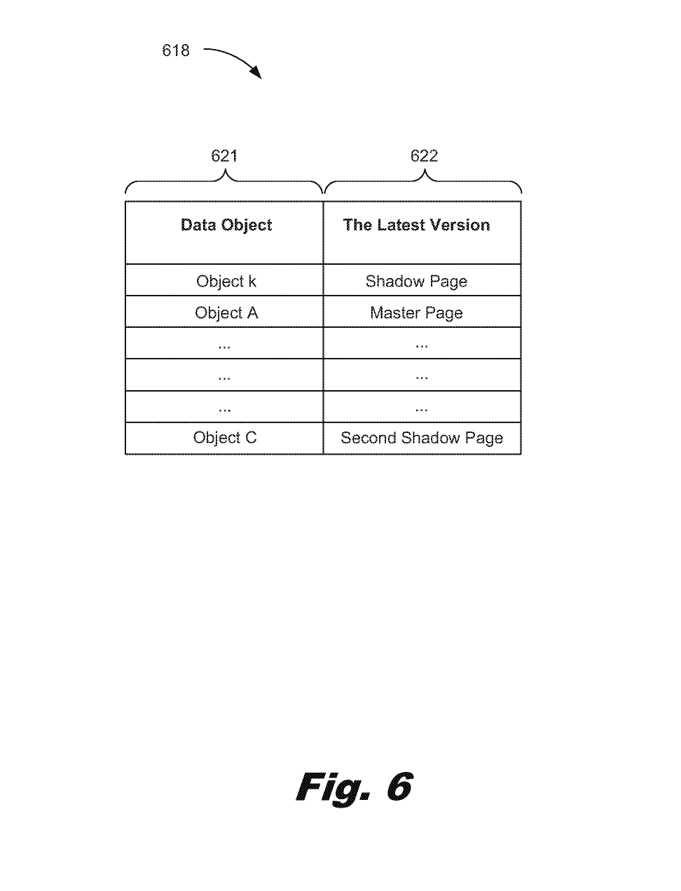

The version controller (503) also may include a version indicator table (518) that indicates which of the multiple physical memory pages (FIG. 3, 314, 315) contains the latest version of the data. More detail concerning the version indicator table (518) is given below in connection with FIG. 6.

The version controller (503) also may include an address calculator (517) that computes the true physical address of the data. The address calculator (517) may receive the request for a transaction to be performed on data. The address calculator (517) may compute the true physical address of the data based on the mapping functions (511) in the page descriptors (516) and the memory address in the request (512).

The memory request scheduler (519) may schedule transactions (513) to be performed on a physical memory page (FIG. 3, 314, 315) based on information received from the address calculator (517) and the version indicator table (518). Accordingly, the memory request scheduler (519) may determine which of the multiple physical memory pages (FIG. 3, 314, 315) contains the latest version of the data based on information received from the page descriptors (516). The request buffer (520) may then carry out a transaction (513) on a physical memory page (FIG. 3, 314, 315) that does not contain the latest version of the data.

FIG. 6 is a version indicator table (618), according to examples of the principles described herein. As described above, the version indicator table (618) may indicate which region or pages of the multiple physical memory pages (FIG. 3, 314, 315) contain the latest version of the data. The version indicator table (618) may include a data object field (621) that indicates the data object. The version indicator table (618) may include a latest version field (622) that indicates what page of the multiple physical memory pages (FIG. 3, 314, 315) contain the latest version of the data. For example, the latest version field (622) may indicate that a latest version of data object “Object k” is located on a shadow physical memory page (FIG. 3, 315). Similarly, the latest version field (622) may indicate that a latest version of the data object “Object A” is located on a master physical memory page (FIG. 3, 314).

As described earlier, after a transaction (FIG. 3, 313) is completed, the version indicator table (618) may be updated. For example, an atomic transaction may be requested to be performed to data object “Object k.” The version indicator table (618) may track pages that are touched by the atomic transaction and change version information for all the touched pages atomically at the end of the atomic transaction. For example, after an atomic update to the data object “Object k,” the version indicator table (618) may be updated to reflect that the master physical memory page (FIG. 3, 314) now contains the latest version of “Object k” based on the atomic update performed.

While FIG. 6 depicts two specific entries in the version indicator table (618) that indicate two physical memory pages (FIG. 3, 314, 315) that map to a virtual memory page, any number of entries may correspond to any number of data objects (621). Moreover, the version indicator table (618) may also facilitate any number of mappings. For example, data object “Object 3” may have a one-to-many mapping. In the example depicted in FIG. 6, the version indicator table (618) may indicate that a second shadow physical memory page has the latest version of the data object (621) “Object C.” Moreover, in some examples, the version indicator table (618) may indicate what version of the data each physical memory page (FIG. 3, 314, 315) contains.

Methods and systems for establishing atomic and durable memory using a versioned memory design may (1) provide atomicity and durability without explicitly writing multi-versioning procedures; (2) facilitate simple and intuitive interfaces that may support various applications and memory updates; (3) eliminate redundant writes to temporary data buffers and central processing unit (CPU) cache; (4) scale and implement atop existing servicer and data center designs; (5) alleviate bandwidth pressure of the memory bus; and (6) enable persistent memory without over-committing memory resources and capabilities.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for mapping virtual memory pages to physical memory pages, comprising:
receiving a mapping of a virtual memory page to multiple physical memory pages;
detecting a request for a transaction to be performed on data contained in the multiple physical memory pages, in which a transaction comprises a number of data updates;
determining which of the multiple physical memory pages contains a latest version of a portion of the data to be updated by the transaction;
updating a physical memory page by performing the transaction within a physical memory page among the multiple physical memory pages that does not contain the latest version of the data; and
updating an indication of which of the physical memory pages contains the latest version of the data pertaining to the transaction.

2. The method of claim 1, in which the indication is a version indicator table that indicates which of the multiple physical memory pages contains the latest version of the data for the current transaction.

3. The method of claim 2, further comprising redirecting a request for a transaction based on the update to the version indicator table.

4. The method of claim 1, in which a portion of a number of virtual memory pages are mapped to a physical memory location, in which the physical memory location comprises a master physical memory page and a shadow physical memory page for the number of virtual memory pages.

5. The method of claim 1, further comprising undoing a number of data updates when the transaction fails, the transaction is aborted, a system fails, or combinations thereof.

6. The method of claim 1, further comprising initializing a number of shadow physical memory pages of the multiple physical memory pages, in which initializing includes copying data from a master physical memory page to the number of shadow physical memory pages.

7. The method of claim 6, in which a number of shadow physical memory pages are initialized while data updates are being performed on other pages of the multiple physical memory pages.

8. The method of claim 1, further comprising receiving an indication of transaction boundaries.

9. A system for mapping virtual memory pages to physical memory pages, comprising:
a processor;
memory communicatively coupled to the processor; and
a version controller, the version controller comprising:
a page descriptor module to receive a mapping of a virtual memory page to multiple physical memory pages;
a version indicator table to indicate which of the multiple physical memory pages contains a latest version of data for the current transaction represented by the virtual memory page;
a request buffer to perform a number of updates on one of the multiple physical memory pages; and
a table update module to update the version indicator table after one of the multiple physical memory pages has been updated.

10. The system of claim 9, in which the memory is non-volatile memory.

11. The system of claim 9, in which the version controller is located on the memory.

12. The system of claim 9, in which the version controller is located on the processor.

13. The system of claim 9, further comprising an address calculator to redirect a request for a transaction based on the version indicator table and the mapping.

14. The system of claim 9, in which the page to which a number of updates are performed is a page that does not contain a latest version of the data.

15. A computer program product for mapping virtual memory pages to physical memory pages, the computer program product comprising:
a computer readable storage medium comprising computer usable program code embodied therewith and executed by a processor to:
detect a number of updates to be performed on data contained in multiple physical memory pages;
identify a master page of the multiple physical memory pages, in which the master page contains the latest version of the data;
perform the data updates on a shadow page, in which a shadow page is a page of the multiple physical memory pages that does not contain the latest version of the data; and
update an indication of which of the multiple physical memory pages contains the latest version of the data.
